(19) United States
(12) Patent Application Publication
(10) Pub. No.: US 2011/0091269 A1
(43) Pub. Date: Apr. 21, 2011

(54) JOINERY CONNECTION ASSEMBLY

(75) Inventors: David Kenning SOLLY, New Plymouth (NZ); Ian Paul BAINES, New Plymouth (NZ); Matthew John COCHRAN, New Plymouth (NZ)

(73) Assignee: OPEN BUILDING SOLUTIONS LIMITED, New Plymouth (NZ)

(21) Appl. No.: 12/908,356

(22) Filed: Oct. 20, 2010

(30) Foreign Application Priority Data
Oct. 20, 2009 (NZ) 580566

(51) Int. Cl. E06B 7/10; E06B 7/14

(52) U.S. Cl. 403/37

(57) ABSTRACT

A joinery connection assembly for joining frame members together at a joint includes spigot mounting, spigot with cam surfaces and cam lock having cam surfaces thereon. The spigot is slidably inter fitted with the spigot mounting to provide a spigot portion protruding there from. The cam surfaces slidably inter lock with each other, such that one frame member is pulled to another frame member to form the joint assembly. A method of assembly is also included.

The invention relates to a joinery connection assembly and to a method of assembly. The invention is directed particularly but not solely towards a joinery assembly which includes attaching one frame member to another frame member such as a mullion to another mullion frame member of a window frame or for attaching any frame member oriented at an angle to another frame member for use in building construction.

### BACKGROUND OF INVENTION

In any building construction there is a need to be able to quickly assemble window and door frames. Existing methods can be time consuming and prone to failure. Failure of any frame member joint can include structural failure which can allow entry of moisture such as rain in or even comprise the security of the building.

Fastener penetrations such as by screws often lead to frame joints leaking as a result of the penetrations through the frames. A traditional screwed joint is difficult to replace once installed in the building especially if the joint becomes damaged. Thermal bridging is another problem that can occur with traditional window frames which can allow a loss of heat from the building.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT OF THE INVENTION

It is an object of the invention to provide joinery connection assembly for joining frame members and a method of installation that ameliorates some of the disadvantages and limitations of the known art or at least provide the public with a useful choice.

### SUMMARY OF INVENTION

In a first aspect the invention resides in an improved joinery connection assembly for joining frame members together at a joint, the assembly including spigot mounting means, spigot means with camming surfaces, and the assembly also including cam lock means also having camming surfaces thereon whereby the spigot means is slidably inter fitted with the spigot mounting means to provide a spigot portion protruding there from said spigot mounting means when mounted there with, and said camming surfaces of the spigot means and cam lock means slidably inter-locking with each other, such that the frame members are pulled together at the joint to form the assembled joint.

Preferably, the spigot mounting means is fixed to one of the frame members and the cam lock means is slidably inter fitted with the other frame member wherein the frame members include a first and second frame member.

Preferably a fixing means fixes the spigot mounting means to the second frame member without fully penetrating second frame member.

Preferably the spigot mounting means includes anchor means shaped and adapted to anchor to a portion of the second frame member.

Preferably, the spigot mounting means is slidably captured by the first frame member.

Preferably the said one of the first and second frame members can be a mullion and the other frame member can be a mullion or transom member.

Preferably, the spigot means is fabricated from stainless steel or any other material that can be machined or cast or moulded.

Preferably the spigot mounting means, spigot means and cam lock means can be formed from a different material to that of the frame members to prevent thermal bridging across the joint to any adjoining structure.

Alternatively the spigot mounting means and spigot means can be formed from the same material where prevention of thermal bridging is not required

Preferably, the spigot mounting means 10 can be fabricated from high grade polyamide plastics.

Preferably, the cam lock 11 can be fabricated from high grade polyamide plastics.

Preferably, the spigot mounting means is a planar-like member including at least one fixing means aperture for fixing means to allow fixing to the second frame member and another aperture to allow the spigot means to be slidably be fitted upwardly there through and held to provide a protruding portion.

Preferably the spigot mounting means can be an approximately Christmas tree shaped member having an in use upper surface and lower surface, the Christmas tree shaped member including three block like portions including a top portion, middle portion and base portion and protruding means located at the top portion and base portion to allow when in use location of the member within appropriately shaped slots of the frame members whereby the lower surface abuts at least a portion of one frame member and the upper surface and thickness is captured by the other frame member, wherein the fixing means aperture is located in the top portion and spigot aperture can be located within or the middle portion.

Preferably, the first frame member can include vertical frame members like a mullion and the second frame member can include a horizontal frame member like a transom or bottom plate member or rail.

Preferably the cam lock means comprises a tubular structure having an outer surface including camming surfaces in the shape of a thread-like shaped structure thereon which when in use is adapted to slidably abut with the camming surfaces of the spigot means to cause the frame members to be drawn together.

In a second aspect the invention resides in a method of forming a joinery connection assembly for joining frame members together at a joint, the assembly including spigot mounting means, spigot means with camming surfaces and cam lock means also having camming surfaces thereon whereby the spigot means is slidably inter fitted with the spigot mounting means to provide a spigot portion protruding there from, and said cam surfaces slidably inter locking with each other, such that the frame members are pulled together at a joint to form the assembled joint whereby the method includes the following steps:
slide spigot means into the aperture of spigot mounting means to allow the bulb like end to protrude there from;
locate spigot mounting means 10 with fitted spigot means 12, on an outer surface of the second frame member 3 with one hook 21 being slid into slot 21a of the second frame member 3;
affix fixing means 19 into aperture 18 of spigot mounting means 10 and into second frame aperture 45 of the second frame member 3;
locate first frame member 2 over the spigot mounting means 10 to slidably capture the spigot mounting means 10 having the spigot means 12 therewith and with the other slot 22 being slid into the slot 22a of the first frame member 2;
slidably insert cam lock means 11 into first frame aperture 33 of first frame member 2 whereby the spigot means 12 is abutting an inner end of one end 28 of the spigot means 12 and of the curved cam surface 29;
using a key member which is then inserted into the key recess means, to rotate the cam lock means 11 to cause the bulb end 40 and neck area 44 to slide there against to pull the second frame member 3 to the first frame member 2 or vice versa.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be limiting.

### BRIEF DESCRIPTION

The invention will now be described, by way of example only, by reference to the accompanying drawings:

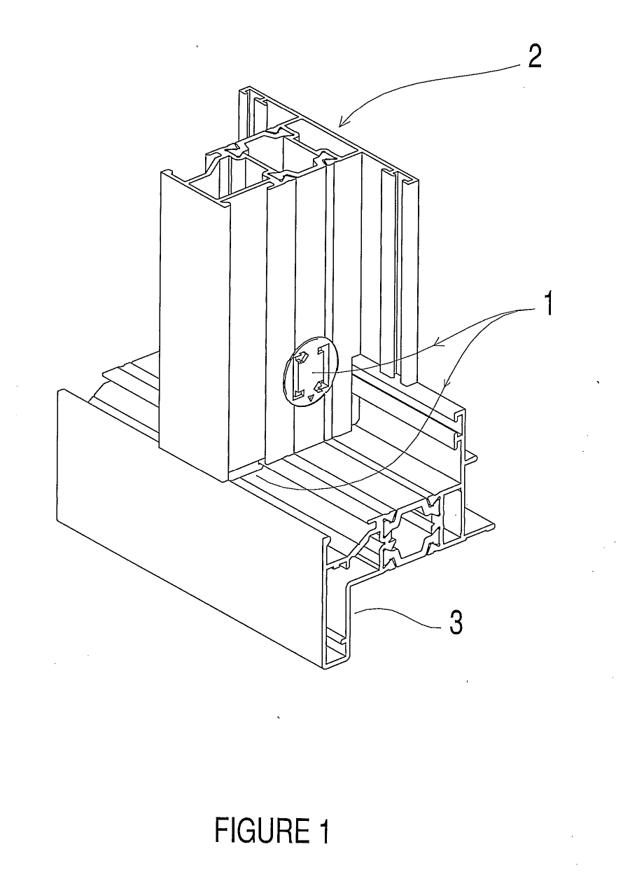

FIG. 1 is a perspective view in accordance with a first preferred embodiment of the invention.

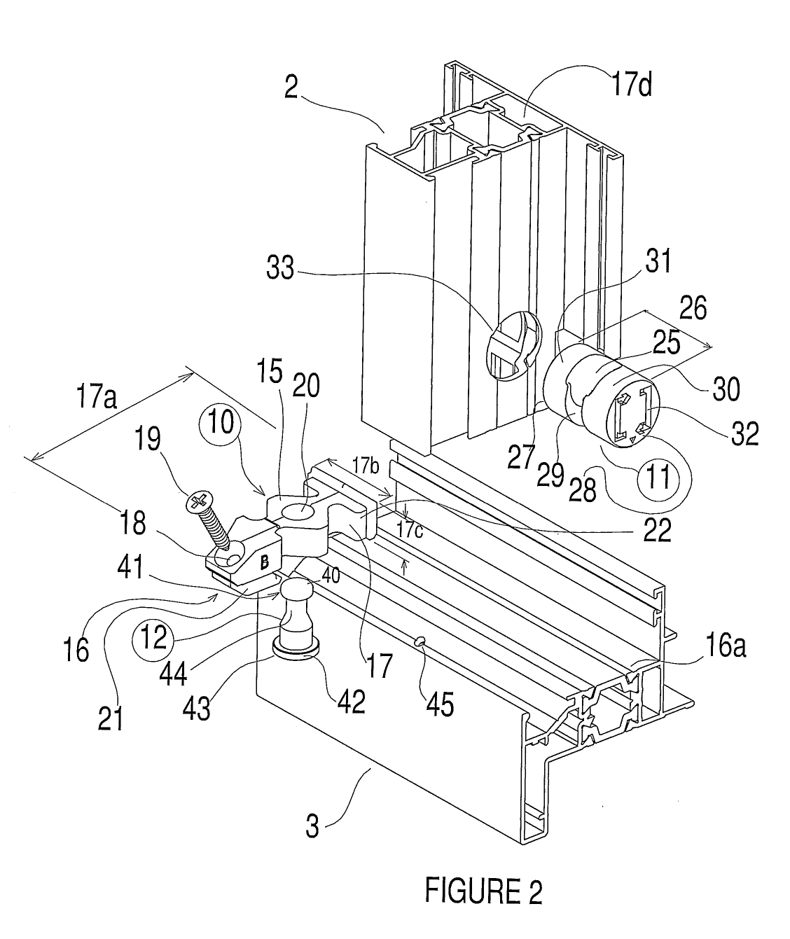

FIG. 2 is a perspective view of the invention in an unassembled assembly.

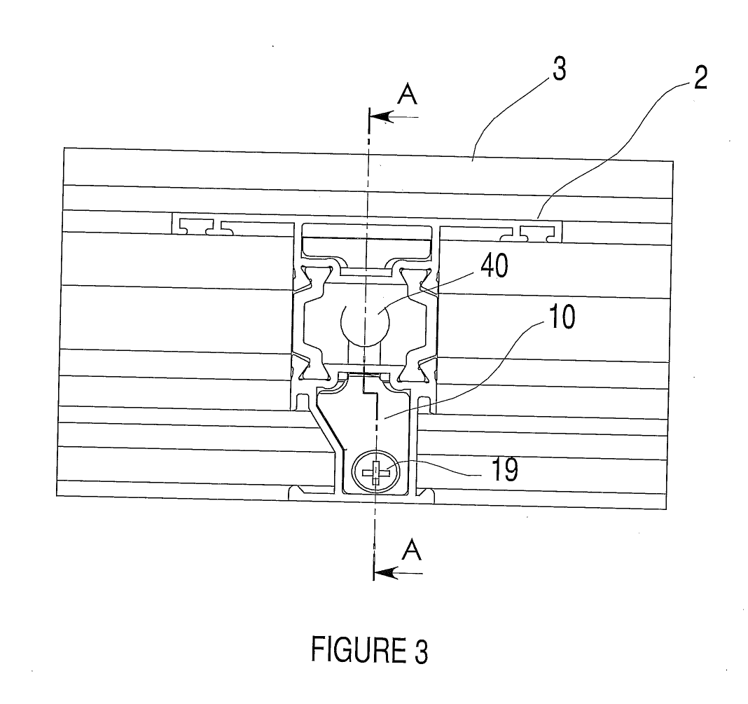

FIG. 3 is a top plan view of the assembly of FIG. 1.

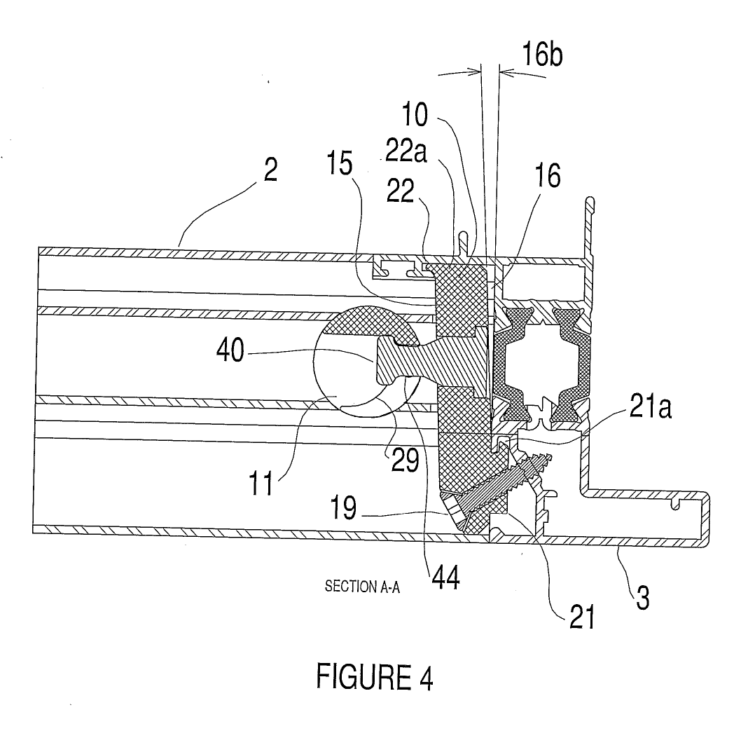

FIG. 4 is a cross section along axis A-A of FIG. 3.

### DESCRIPTION OF DRAWINGS

The following description will describe the invention in relation to preferred embodiments of the invention, namely a cam lock assembly for joining members such as elongate members including frame members and method of installation. The invention is in no way limited to these preferred embodiments as they are purely to exemplify the invention only and that possible variations and modifications would be readily apparent without departing from the scope of the invention.

As shown in the perspective view of FIG. 1 there is a joinery connection assembly 1 for joining frame members as a completed or assembled joint. In this example, the frame members include a first frame member which can be for example a horizontal frame member, window frame, mullion or sill or rail member 2 and a second frame member which can be for example a mullion or vertical member 3. The cam lock assembly includes the following components of a spigot mounting means 10, cam lock means 11 and spigot means 12 all operatively connected or connectable together when assembled to cause the joint to be formed as a tight and stable joint with the frame members 2 and 3 being pulled together.

### Spigot Mounting Means 10

The spigot mounting means 10 as seen in FIGS. 2-4 functions to be fixable to the second frame member 3 while being shaped as a planar-like member having a certain profile to allow when in use the first frame member 2 (ie a mullion or vertical), to be slid over and completely envelop and surround as shown especially in FIG. 3. The first frame member mullion 2 is shaped in cross section to provide at least a slot or recess to slidably receive the spigot mounting means 10. The spigot mounting means 10 is also shaped and adapted to provide rotational stability to the assembled joint when cam lock means 11 is in the closed or final position.

In this example the spigot mounting means 10 includes a body in the general form of a planar-like member having an approximately Christmas tree type shape having an upper planar surface 15, a lower planar surface 16, a peripheral side edge 17, length 17a, width 17b and depth or thickness 17c. The peripheral or outer side edge 17 is shaped in a selected profile to match with or be matched within a corresponding interior shaped recess 17d of the first frame member 2. It should be noted that the shape of the spigot mounting means 10 is shaped to inter-fit with both the first and second frame members but in different aspects, one being the outer edge 17 and the other being the lower surface 16 and length 17a.

The Christmas tree shape has three block like portions joined by a stem ie a top, middle and base portions. The top portion is almost triangular in shape with an angled or sloping upper surface on upper surface 15. The middle portion is star shaped or rectangular but oriented on its corners and the bottom portion is shaped like a base in a rectangular shape. The top portion has the aperture 18 for the fastener 19 and the hook 21 protruding there from. The middle portion has the aperture 20 for the spigot to poke upwardly through and the bottom portion has the hook 22 extending therefrom at one end and another hook extending from the other end of the Christmas tree shaped body.

At least one fixing spigot aperture 18 is located in spigot mounting means 10 which extends from the upper surface 15 through to the lower surface 16 and is adapted to receive a fixing means 19. In this example aperture 18 can be angled with respect to a vertical plane (in use) to allow easier access to install the fixing means 19 therein. Spigot mounting means 10 also has at least another aperture ie a spigot receiving aperture 20 also extending the depth 17c, to slidably receive the spigot means 12 to allow a part of the spigot means 12 to protrude upwardly there from and be held therein.

As can be seen in FIGS. 1 and 4, the fixing means 19 can be a screw which is adapted to penetrate only a portion of the upper surface 15 of the spigot mounting plate 10 without fully penetrating the second frame member 3 to cause leakage into the wall or any other construction being used with the connection assembly and frame members.

As can be seen in FIGS. 2 and 3 the spigot mounting means body is outwardly shaped to match the cross sectional profile of the first frame member 2, which is in an use vertical position having a lower portion, to allow at least the sliding of the spigot mounting means into the lower portion of the cross sectional profile of first frame member 2. The lower surface 16 of spigot mounting means 10 has a shape that allows it to sit on an in use upper surface 16a of the horizontal or second frame member 3 as shown FIGS. 1 & 2. As shown in FIG. 4 lower surface 16 can be spaced from surface 16a at an angle 16b with for example the end fixed by the fixing means 19 abutting surfaces 16 and 16a and the other end of lower surface being spaced from lower surface 16a.

As shown in FIG. 4 lower surface 16 is specifically shaped to match or sit on at least part of, where useful the upper surface 16a of the second frame member 3, and positively anchor to the first frame member 2 by anchor means, to allow the spigot mounting means 10 to pull the first frame member 2 towards the second frame member 3. The anchor means comprises at least protruding means in the form of one hook shaped portion 21. Also there can be another protruding means in the form of a hook shaped portion 22 at an opposite end of the spigot mounting means 10. The hook shaped portions 21 & 22 comprise a protruding portion that is able to hook within corresponding shaped slots 21a and 22a in the first frame member 2 and second frame member 3 as shown in FIG. 4. These hook shaped portions 21 & 22 can protrude in any suitable direction from the body of the spigot mounting means that enables it to be located in appropriately shaped slotted portions of the frame members to be joined together.

The spigot mounting means 10 can be fabricated from high grade polyamide plastic.

### Cam Lock Means 11

The cam lock means 11 as shown in the perspective view of FIG. 2 can be generally a tubular shaped body having an outer surface 25, length 26, distal end 27 and proximal end 28. Outer surface 25 has a raised curved cam surface 29 located between non curved ends 30 & 31 which is formed in a spiral or thread like or curved shape. Proximal end 28 is adapted to have a key recess means 32 whereby in use when the cam lock means 11 is slidably inserted into a matching first frame aperture 33 in mullion 2, the proximal end 28 is left exposed as shown in FIG. 1. Key recess means 32 is particularly shaped to inter-fit with a special key member (not shown) which will in use, allow the cam lock means 11 to be turned or rotated within the recess 33.

The cam lock 11 can be fabricated from high grade polyamide plastic.

### Spigot Means 12

Spigot means 12 is a tubular or elongate shaped member having a first protuberance 40 located at a distal end 41 and a second protuberance 42 located at a proximal end 43 with a necked portion 44 in between. In use the first protuberance 40 with most of the neck portion will protrude beyond the upper surface 15 of the spigot mounting means 10. In this example the necked portion 44 includes a cylindrical portion co-joined to a curved reducing cylindrical portion whereby the cylindrical portion is located co-joined to the proximal end 43.

First protuberance 40 is bulb-like in shape and is adapted to in use be inserted into aperture 20 of the spigot mounting means 10 and second protuberance 42 is planar-like in shape and is adapted when in use to sit flush with and abutting onto the spigot mounting means lower surface 16 as shown in FIG. 4. The first protuberance 40 and neck portion also provide camming surfaces.

The spigot means 12 can be formed of stainless steel.

### Frame Members

As shown in FIG. 2 the second frame member or horizontal frame member 3 has a second frame aperture 45 which allows the fixing means 19 to be attached to the horizontal frame member 3. First frame member or vertical frame member 2 has also been adapted to allow the cam lock means 11 to be slidably inserted therein whereby the first frame aperture 33 has been created. For example frame members 2 and 3 can be fabricated from aluminium.

As in any joining of frame members 2 & 3 there can be the problem of there being no thermal break there between. To solve this problem, the spigot mounting means 10 and cam lock means 11 are fabricated from high grade polyamide plastic. The spigot means 12 is fabricated from stainless steel to better allow the sliding over cam curve surfaces 29 of the cam lock means 11.

### Joining the Frame Members

As shown in FIGS. 3 and 4 the assembly 1 can include the following steps:
slide spigot means 12 into the aperture 20 of spigot mounting means 10 to allow the bulb like end 40 to protrude there from;
locate spigot mounting means 10 with fitted spigot means 12, on an outer surface of the second frame member 3 with one hook 21 being slid into slot 21a of the second frame member 3;
affix fixing means 19 into aperture 18 (set at angle to the horizontal) of spigot mounting means 10 and into second frame aperture 45 of the second frame member 3;
locate first frame member 2 over the spigot mounting means 10 to slidably capture the spigot mounting means 10 having the spigot means 12 therewith and locating the other hook 22 into slot 22a of the first frame member;
slidably insert cam lock means 11 into first frame aperture 33 of first frame member 2 whereby the spigot means 12 is abutting an inner end of one end 28 of the spigot means 12 and of the curved cam surface 29;
using a key member (not shown) which is then inserted into the key recess means 32, to rotate the cam lock means 11 to cause the bulb end 40 and neck area 44 to slide there against to pull the second frame member 3 to the first frame member 2 or vice versa.

This method can be varied for example by locating the first frame 2 onto the second frame 3 before sliding the insert cam lock means 11 into the second frame aperture 33. Also inserting the cam lock means 11 can be carried out before fitting the spigot means 12 to the spigot mounting means 10.

The camming action includes the rotating of the key means to directly cause the cam lock means 11 to rotate (with respect to the frame member 2 that is associated with the cam lock means 11) with the camming surfaces 29 of the cam lock means 11 also rotating about the head and neck of the spigot means 12 thereby drawing or pulling the spigot means 12 and the spigot mounting means 10 connected first frame member 2 towards the second frame member 3 or vice versa.

This formed joint between elongate members can be stable enough to allow for quick and easy replacement of any component parts such as the mullions 2, transoms 3 or frame members or glazing without damaging the rest of the frame members.

By having the spigot mounting means 10 and cam lock means 11 formed from a different material to that of the frames, thermal bridging can be prevented or reduced. Other material combinations are equally possible such as for example using similar materials if thermal bridging does not need to be prevented.

### Advantages

a) Simple operation

b) Prevention of thermal bridging of frame members

c) Few parts

d) Modest cost

e) Rapid installation

f) Robust construction

g) No specialized equipment is needed

h) Can be used in a structural or non structural frame

i) Easy to assemble and Disassemble frame assemblies

j) Mullions and transoms can be easily replaced if damaged

k) No full penetration of frame member to cause leakage.

1) Different angled joints are possible.

### Variations

Throughout the description of this specification, the word “comprise” and variations of that word such as “comprising” and “comprises”, are not intended to exclude other additives, components, integers or steps.

Instead of the mullion and bottom plate as shown, the joint of the invention is not limited to just frame members or even just elongate members but can be used with any combination of members which intersect at any angle can be used by the assembly of the present invention. The outward shape of the spigot mounting means 10 does not need to exactly match the internal profile of mullion 2 or even be exactly Christmas-tree shaped but should be able to be slidably captured by a lower portion of the mullion 2 and be able to inter-fit with both frame members. Though the upper and lower surfaces 15 & 16 are stated as being planar this does not necessarily mean that those surfaces have to be flat but they can include various angles, steps or curves like as shown in FIG. 2 e.g. an angled upper surface at one end to allow the fixing and a protruding lower portion on the lower surface 16, to fit into the upper surface of the second frame member 3. Also the outward edge 17 can be straight or curved or angled as required.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

The cam lock means 11 can also be shaped in other shapes as long as it is able to be slidably fitted within the aperture of mullion 2. Cam lock means 11 and spigot means 12 can be a solid or hollow member and shaped as required. The spigot means or any other component of the joinery connection assembly can be fabricated from stainless steel or any other material that can be machined or cast or moulded.

Though a bottom plate frame member 3 and mullion 2 are shown in use with the cam lock assembly of the present invention other orientation of frame members are equally possible. Equally other profiles are also possible. The profiles of the frame members should have a cross section that forms a cavity therein so that any fixing by either the spigot and spigot mounting means and cam lock means are not able to protrude completely through there section to transfer moisture through to any connecting structure.

The method can be varied such as by slidably inserting the cam lock means 11 before fixing the spigot mounting means 10. Other means of fixing the spigot mounting means 10 are also possible such as by using more fixing means or by using more than one assembly per joint. The number of apertures in spigot mounting means can be varied as required such as to have more fixing apertures 19 which can also including other fixing both removable or not and other than screws like, bolts or even fusing or welding if necessary. The spigot means 12 can include other shapes as long is it able to be both affixed to the frame and provide camming surfaces.

It will also be understood that where a product, method or process as herein described or claimed and that is sold incomplete, as individual components, or as a “kit of Parts”, that such exploitation will fall within the ambit of the invention.

1. A joinery connection assembly for joining frame members together at a joint, the assembly including spigot mounting means, spigot means with camming surfaces, and the assembly also including cam lock means also having camming surfaces thereon whereby the spigot means is slidably inter fitted with the spigot mounting means to provide a spigot portion protruding there from said spigot mounting means when mounted there with, and said camming surfaces of the spigot means and cam lock means slidably inter-locking with each other, such that the frame members can be pulled together to form an assembled joint.

2. The joinery connection assembly as claimed in claim 1 wherein, the spigot mounting means is fixed to one of the frame members and the cam lock means is slidably inter fitted with the other frame member wherein the frame members includes a first and second frame member.

3. The joinery connection assembly as claimed in claim 2 wherein, a fixing means fixes the spigot mounting means to the second frame member without fully penetrating the second frame member.

4. The joinery connection assembly as claimed in claim 3 wherein, the spigot mounting means includes anchor means shaped and adapted to anchor to a portion of the second frame member.

5. The joinery connection assembly as claimed in claim 4 wherein, the spigot mounting means is slidably captured by the first frame member.

6. The joinery connection assembly as claimed in claim 5 wherein, the said one of the first and second frame members can be a mullion and the other frame member can be a transom member

7. The joinery connection assembly as claimed in claim 6 wherein, the spigot means is fabricated from stainless steel or any other material that can be machined or cast or moulded.

8. The joinery connection assembly as claimed in claim 7 wherein, the spigot mounting means, spigot means and cam lock means can be formed from a different material to that of the frame members to prevent thermal bridging across to the joint to any adjoining structure.

9. The joinery connection assembly as claimed in claim 7 wherein, the spigot mounting means and spigot means can be formed from the same material where prevention of thermal bridging is not required.

10. The joinery connection assembly as claimed in claim 8 wherein, the spigot mounting means can be fabricated from high grade polyamide plastics.

11. The joinery connection assembly as claimed in claim 10 wherein, the cam lock 11 can be fabricated from high grade polyamide plastics.

12. The joinery connection assembly as claimed in claim 11 wherein, the spigot mounting means is a planar-like member including at least one aperture for fixing means to allow fixing to the first frame member and another aperture to allow the spigot means to be slidably fitted there through and held to provide a protruding portion with a camming surface.

13. The joinery connection assembly as claimed in claim 12 wherein the spigot mounting means can be an approximately Christmas tree shaped member having an in use upper surface and lower surface, the Christmas tree shaped member including three block like portions including a top portion, middle portion and base portion and protruding means located at the top portion and base portion to allow when in use location of the member within appropriately shaped slots of the frame members whereby the lower surface abuts at least a portion of one frame member and the upper surface and thickness is captured by the other frame member, wherein the fixing means aperture is located in the top portion and spigot aperture can be located within or the middle portion.

14. The joinery connection assembly as claimed in claim 13 wherein, the first frame member can include vertical frame members like a mullion and the second frame member can include a horizontal frame member like a transom or bottom plate member or rail.

15. The joinery connection assembly as claimed in claim 14 wherein, the cam lock means comprises a tubular structure having an outer surface being camming surfaces in the shape of a thread-like shaped structure thereon which when in use is adapted to slidably abut with the camming surfaces of the spigot means to cause the frame members to be drawn together.

16. A joinery connection assembly substantially as herein before described with reference to the figures of the accompanying drawings.

17. The joinery connection assembly as claimed in claim 9 wherein, the spigot mounting means can be fabricated from high grade polyamide plastics.
